(19) United States
(12) Patent Application Publication
(10) Pub. No.: US 2021/0225405 A1
(43) Pub. Date: Jul. 22, 2021

(54) HARD DISK DRIVE LIFETIME FORECASTING

(71) Applicant: HEWLETT-PACKARD DEVELOPMENT COMPANY, L.P., Spring, TX (US)

(72) Inventor: Roberto Coutinho, Porto Alegre (BR)

(21) Appl. No.: 16/604,126

(22) PCT Filed: Jan. 31, 2018
(86) PCT No.: PCT/US2018/016137

§ 371 Date: Oct. 9, 2019

(51) Int. Cl. G11B 20/18; G06F 11/00; G06F 11/30

(52) U.S. Cl. CPC G11B 20/1816; G06F 11/3034; G06F 11/008

(57) ABSTRACT

Examples disclosed herein relate to collecting a plurality of sensor data associated with a hard disk drive, calculating a health factor for the hard disk drive according to the plurality of sensor data, calculating a health offset for the hard disk drive according to the plurality of sensor data, and generating a remaining lifetime forecast for the hard disk drive according to an estimated overall lifetime for the hard disk drive, the health factor for the hard disk drive, and the health offset for the hard disk drive.

### BACKGROUND

Electronic components, such as hard disk drives (HDDs), may be used to store data for devices such as computers and printers. A hard disk drive may, for example, use magnetic storage to store and retrieve digital information using one or more rigid rapidly rotating disks (platters) coated with magnetic material and/or may store data on flash memory in the form of a solid-state drive (SSD). HDDs are a type of non-volatile storage, retaining stored data even when powered off.

### BRIEF DESCRIPTION OF THE DRAWINGS

FIG. 1 is a block diagram of an example computing device for providing hard disk drive lifetime forecasting.

FIG. 2 is a block diagram of an example system for providing hard disk drive lifetime forecasting.

FIG. 3 is a flowchart of an example method providing hard disk drive lifetime forecasting.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Many given components in an electronic system, such as computers, laptops, printers, copiers, multi-function devices, etc. have a working lifetime. After this lifetime, which may end due to wear, failure, errors, damage, or other reasons, these components need to be replaced. Predicting the remaining lifetime of these components so that they can be replaced as near to the end of their workable lifetime but before the components fail completely is important for cost efficiency to owners and/or operators of these devices.

A hard disk drive (HDD) is a data storage component in many electronic devices. Predicting the lifetime for a HDD is especially important because failure to replace the HDD before it fails may result in a loss of critical data stored on the HDD. Many HDDs are equipped with sensors to provide information about their health and status, but these sensors only provide a current state of the drive rather than any failure predictions. This data, however, can be analyzed to determine trends and identify which factors tend to result in failure indicators. These factors can be combined with a knowledge of average operating lifetime lengths to forecast a remaining lifetime for the HDD and ensure that a replacement occurs before that lifetime ends.

For example, many HDDs employ sensors referred to as Self-Monitoring, Analysis, and Reporting Technology (S.M.A.R.T.) to detect and report on various indicators of drive reliability. These sensors report data counts such as a read error rate, start/stop cycles, reallocated sector count, power-on hours, used and/or unused reserved block count, command timeouts, and many others. Forecasting a remaining lifetime for a HDD may take advantage of this sensor data as well as other data such as average lifetimes for a particular brand and/or model of drive, operating temperature, and/or damage detection, such as shock and/or moisture sensors. For example, an industry average for HDD lifetime may comprise 43,800 operating hours or 1825 days. This average may vary by manufacture—such data may be provided by manufacturers and/or component testing and review sites and/or it may be gathered via observation across multiple devices. In some implementations, a computer manufacturer may use three models of hard drives in its products—Model A, Model B, and Model C. Based on data gathered during service calls and/or warranty replacements, for example, the manufacturer may identify an average lifetime of 1855 days for Model A HDDs, an average lifetime of 1810 days for Brand B HDDs, and an average lifetime of 1904 days for Model C HDDs. This specification will refer to these examples throughout purely for illustrative purposes; these average lifetimes are not intended to be representative of any specific brand or model of hard drive on the market.

The average lifetime, either generically across all HDDs and/or as a brand or model specific average may be used as a baseline for forecasting the remaining lifetime for a given HDD. One sensor reading from a HDD may comprise a Power On Time Count, which identifies the total time the HDD has been powered on. This value may be reported in any given time unit (e.g., seconds, hours, days, etc.) depending on brand, model, and/or manufacturer, but the time unit is known and can be converted to days for ease of calculation. For an example HDD reporting 347 days in use, a simple lifetime forecast may simply subtract the 347 days from the average 1825 days resulting in a forecast of 1478 days remaining. For illustrative purposes, the examples given herein show the health calculations as a count of days, but other time units (e.g., hours) are just as applicable.

This simple forecast, however, does not consider the health and other factors that may be affecting the operation of this particular HDD. A second component for forecasting the remaining lifetime may comprise a health value of the HDD, represented as a percentage value from 1-100% and associated with a general health of the HDD. The health value may be calculated by gathering a number of HDD attributes from the appropriate sensors, normalizing those attributes to a percentage, and assigning a weight to each attribute, as described in greater detail below. In some implementations, the health value may be further modified by an average operating temperature attribute.

The remaining lifetime forecast may further consider a health offset, calculated according to other elements of data specific to the HDD. For example, a reallocated sector count, a shock sensor count, and an average working time may factor into generating a health offset value for the HDD's forecasted lifetime, as described in greater detail below.

By applying the health value and health offset calculations to the estimated remaining lifetime, according to an average lifetime for the HDD, a remaining lifetime forecast may be made. This forecast may be used to generate alerts and/or service calls, for example, to replace the drive before it fails and/or data is lost.

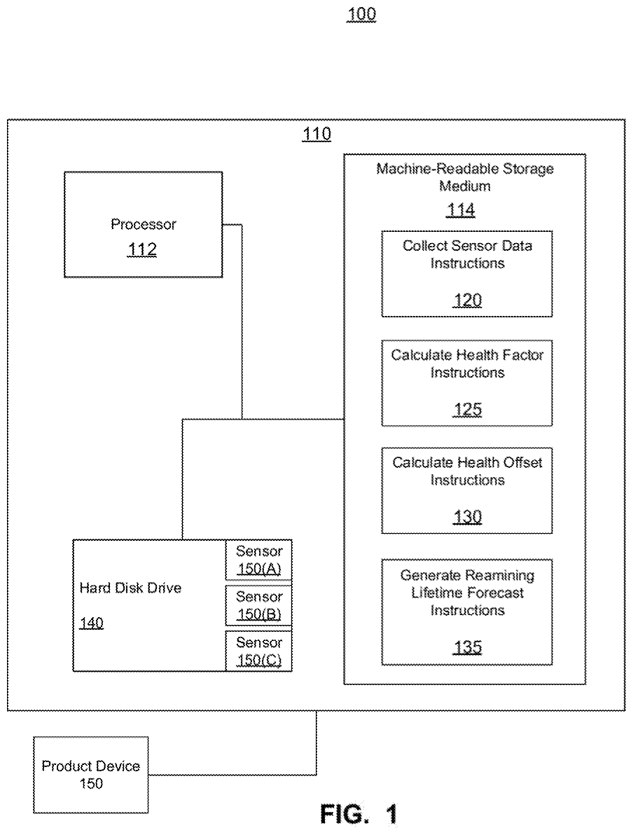

FIG. 1 is a block diagram of an example computing device 110 for providing hard disk drive lifetime forecasting. Computing device 110 may comprise a processor 112 and a non-transitory, machine-readable storage medium 114. Storage medium 114 may comprise a plurality of processor-executable instructions, such as collect sensor data instructions 120, calculate health factor instructions 125, calculate health offset instructions 130, and generate remaining lifetime forecast instructions 135. In some implementations, instructions 120, 125, 130, 135 may be associated with a single computing device 110 and/or may be communicatively coupled among different computing devices such as via a direct connection, bus, or network.

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute instructions 120, 125, 130, 135.

Executable instructions 120, 125, 130, 135 may comprise logic stored in any portion and/or component of machine-readable storage medium 114 and executable by processor 112. The machine-readable storage medium 114 may comprise both volatile and/or nonvolatile memory and data storage components. Volatile components are those that do not retain data values upon loss of power. Nonvolatile components are those that retain data upon a loss of power.

The machine-readable storage medium 114 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Collect sensor data instructions 120 may collect a plurality of sensor data associated with a hard disk drive 140 comprising a plurality of sensors 150(A)-(C). For example, sensors 150(A)-(C) may comprise S.M.A.R.T. specification compatible sensors configured to provide data to a Built-In Operating System (BIOS), user Operating System (OS), application, firmware, and/or other executable program associated with computing device 110. Such sensors may comprise, for example, error count sensors, operational sensors (e.g., temperature, speed, and/or power-on time, etc.), and/or damage sensors (e.g., shock sensors and/or moisture sensors, etc.).

Calculate health factor instructions 125 may calculate a health factor for the hard disk drive according to the plurality of sensor data. In some implementations, the health factor may be calculated according to a first subset of sensor data of the plurality of sensor data. The first subset of sensor data may comprise, for example a read error count, a command timeout count, a reallocated sectors count, and an uncorrectable sector count.

The health factor may be based on an intermediate health value and/or an average operating temperature. The intermediate health value of the HDD 140 may be represented as a percentage value from 1-100% and associated with a general health of the HDD 140. The health value may be calculated by gathering a number of HDD 140 attributes from the appropriate sensors 150(A)-(C), normalizing those attributes to a percentage, and assigning a weight to each attribute.

The average operating temperature of HDD 140 may be reported, for example, as an Airflow Temperature attribute, which is the temperature of the air inside the hard disk housing. The average temperature often has a direct correlation to determine the lifetime of a HDD, and the HDD lifetime may be reduced drastically.

Each of the sensor data used to calculate the intermediate health value may be normalized into a proportional percentage of a current attribute value compared to a maximum value for that attribute. This also allows for normalization across manufacturers as different manufacturers may use different ranges and maximums. For example, a Model A HDD may report a current Reallocated Sector Count of 13 out of a maximum of 100, while a Model B HDD may report a current Reallocated Sector Count of 33 out of a maximum of 255. Normalizing these scores results in both HDDs showing a Reallocated Sector Count score of 13%. In some implementations, the attribute values may be inverted, such that the value decreases as the number of errors increase. For example, Model C may report a Reallocated Sector Count value of 87 out of a maximum of 100 to represent the same count of bad sectors that have been found and remapped on the HDD, resulting in the same 13% Reallocated Sector Count score as Model A and Model B received. An example list of attributes and weights that may be used to calculate the intermediate health value are given in Table 1, below.

TABLE 1

| ATTRIBUTE | WEIGHT |
|---|---|
| Reallocated Sector | 0.2 |
| Count | |
| Raw Read Error Count | 0.2 |
| End-to-End Error | 0.1 |
| Count | |
| Command Timeout | 0.1 |
| Reallocation Event | 0.1 |
| Count | |
| Current Pending | 0.1 |
| Sector Count | |
| Offline Uncorrectable | 0.2 |
| Sector Count | |

The Reallocated Sector Count may comprise a raw value representing a count of the bad sectors that have been found and remapped. The Raw Read Error Count may store data related to the rate of hardware read errors that occurred when reading data from a disk surface. The End-to-End Error Count may comprise a count of parity errors that occur in a data path to the HDD via a drive's cache RAM. A Command Timeout may comprise a count of aborted operations due to HDD timeout. A Reallocation Event Count may comprise a total count of attempts to transfer data from reallocated sectors to a spare area. A Current Pending Sector Count may comprise a count of unstable sectors that are waiting to be remapped due to unrecoverable read errors. An Offline Uncorrectable Sector Count may comprise a total count of uncorrectable errors when reading and/or writing a sector of the HDD. These attributes and their weights are given as examples only. Other attributes may also be used to generate the intermediate health value and different weights may be ascribed to different calculations. For example, calculations for a Model A HDD may weight the Reallocation Event Count as 0.2 instead of 0.1 while weighting the Reallocated Sector Count as 0.1 instead of 0.2.

Each normalized attribute may be assigned a weight to be considered when generating the health factor. For example, the reallocated sector count attribute may be assigned a weight of 0.2 while a command timeout count may be assigned a weight of 0.1, giving the reallocated sector count attribute twice as much influence on the resulting health factor.

The health value may then be calculated by subtracting each of the normalized, weighted attributes from a starting score of 100. For example, the normalized reallocated sector count of 13%*0.2 results in a weighted value of 2.6. Subtracted from 100, this makes the health value of a given HDD equal to 97.4. For example, HDD 140 may comprise normalized attributes as follows: a reallocated sector count of 3%, a raw read error count of 7%, an end-to-end error count of 10%, a command timeout count of 0%, a reallocation event count of 12%, a current pending sector count of 4% and an offline uncorrectable sector count of 5%. The resulting intermediate health value may then be calculated as:

100−(13*0.2)−(7*0.2)−(10*0.1)−(0*0.1)−(12*0.1)−(4*0.1)−(5*0.2)=100−2.6−1.4−1−0−1.2−0.4−1=92.4%

To calculate the health factor from the intermediate health value, Equation 1 may be used:

Health Factor=(Health²−((Avg*C²)²)

Thus, the Health Factor for HDD 140 having the intermediate health value of 92.4% and an example average operating temperature of 60° C. (Normalized to 0.6) would be 72% according to Equation 1, applied thusly: 0.924²−((0.6)²)²=0.8538−0.1296=0.7242.

Calculate health offset instructions 130 may calculate a health offset for the hard disk drive 140 according to the plurality of sensor data. In some implementations, the health offset may be calculated according to a second subset of sensor data of the plurality of sensor data. The second subset of sensor data may comprise, for example, a drive power cycle count, a shock sensor count, an average temperature, and a reallocated sectors count. In some implementations, the health offset may comprise at least one of the second subset of sensor data divided by a total power on time of the hard disk drive 140.

The health offset may define each sensor data value in terms of a total power on time for the drive. For example, the health offset may be calculated according to Equation 2:

$$( \frac{PowerOnTime}{DrivePowerCycle} + \frac{shock}{PowerOnTime} + \frac{reallocated}{PowerOnTime} ) \qquad Equation 2$$

A Power On Time sensor datum may comprise a count of time units the HDD has spent in a powered-on state. The raw value of this attribute may show a total count of hours, minutes, seconds, days, etc. in the powered-on state. The Drive Power Cycle sensor datum may comprise a count of HDD power on/off cycles. Thus, Power On Time/Drive Power Cycle may result in an average operating time per cycle. If the Power On Time is high and the Drive Power Cycle is low, it may indicate that the HDD spends many hours working after being started, such as may occur in a server environment. If the Power On Time attribute is low and the Drive Power Cycle attribute is high, it may indicate that the HDD is started many times but with a small amount of usage each time, as may be a typical usage from a single person at their personal computer. For example, HDD 140 may comprise a Power On Time of 8359 hours (348.2917 days) and a Drive Power Cycle Count of 1667, giving an average of 5.0 hours (0.2083 days) per power cycle.

Another attribute that may influence the hard disk lifetime is the number of mechanical and/or damage errors. For example, one S.M.A.R.T. sensor attribute is a G-Sense Error Rate that provides a count of errors resulting from shock or vibration. This information may be used as symptom because it may cause damage to a HDD storage surface. The count of the shock sensor may be divided by the Power On Time attribute. For example, a shock sensor count of 9 for HDD 140 divided by the example Power On Time of 348.2917 days gives the value of 0.0258 shocks per day.

The S.M.A.R.T. attribute of Reallocated Sectors Count represents a count of the bad sectors on the HDD that have been found and remapped. Thus, the higher the attribute value, the more sectors the drive has had to reallocate. This value may be used as a coefficient of degradation. To give an estimation in days to subtract from the lifetime, this value will be divided by PowerOnTime. For example, HDD 140 may comprise a Reallocated Sectors Count value of 24728; dividing this value by the power on time of 348.2917 results in a value of 70.998. Combining the three values into Equation 2 thus results in a health offset value of: (5.0+0.0258+70.998)=76.0238. This health offset represents a number of days to be subtracted when forecasting the estimating remaining lifetime.

Generate remaining lifetime forecast instructions 135 may generate a remaining lifetime forecast for the hard disk drive 140 according to an estimated overall lifetime for the hard disk drive 140, the health factor for the hard disk drive 140, and the health offset for the hard disk drive 140. In some implementations, the estimated overall lifetime for the hard disk drive 140 may comprise an average overall lifetime for a plurality of hard disk drives associated with a manufacturer and/or specific model of the hard disk drive 140. The estimated remaining lifetime may be generated using Equation 3, which incorporates the health factor from Equations 1 and the Health Offset from Equation 2:

$$Estimated Remaining Life = ( ( Avg Lifetime - \frac{PowerOnTime}{24} ) * ( Health Factor ) - ( Health Offset ) \qquad Equation 3$$

In the examples given for HDD 140, we start with an average lifetime of 1855 days for a Model A HDD. Subtracting the Power On Time of 8359 hours/24 to get an operating lifetime of 348.2917 days results in a remaining lifetime of 1506.7083 days. This is multiplied by the Health Factor of 0.7242, resulting in 1091.1582 days. Finally, the Health Offset of 76.0238 is subtracted, giving a remaining lifetime forecast of 1015.1344 days for HDD 140.

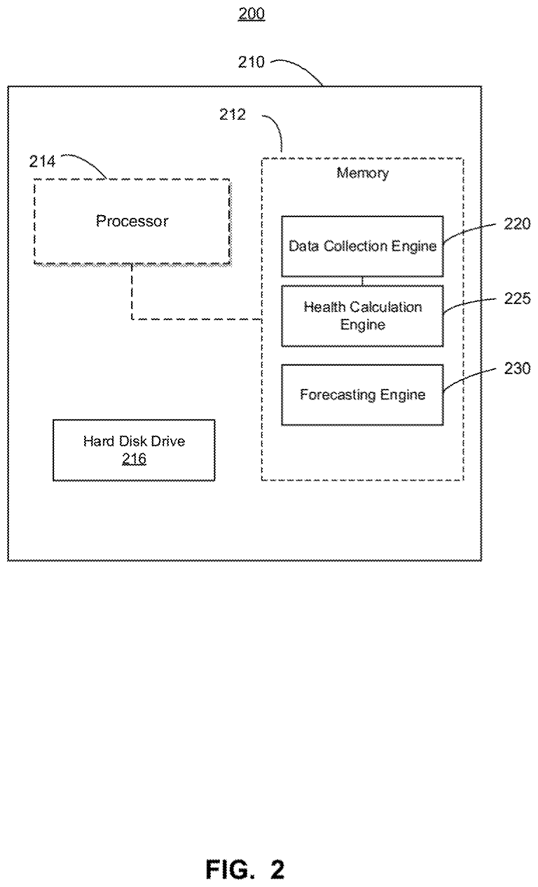

FIG. 2 is a block diagram of an example system 200 for providing hard disk drive lifetime forecasting. System 200 may comprise a computing device 210 comprising a memory 212, a processor 214, and a hard disk drive 216. Computing device 210 may comprise, for example, a general and/or special purpose computer, server, mainframe, desktop, laptop, tablet, smart phone, game console, printer and/or any other system capable of providing computing capability consistent with providing the implementations described herein. Computing device 210 may store, in memory 212, a data collection engine 220, a health calculation engine 225, and a forecasting engine 230.

Each of engines 220, 225, 230 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 220, 225, 230. In such examples, device 210 may comprise the machine-readable storage medium storing the instructions and the processing resource to execute the instructions, or the machine-readable storage medium may be separate but accessible to system 200 and the processing resource.

Data collection engine 220 may collect a plurality of sensor data associated with a hard disk drive. For example, a plurality of sensor data associated with hard disk drive 216 may be collected from a plurality of sensors. For example, the sensors may comprise S.M.A.R.T. specification compatible sensors configured to provide data to a Built-In Operating System (BIOS), user Operating System (OS), application, firmware, and/or other executable program associated with computing device 210. Such sensors may comprise, for example, error count sensors, operational sensors (e.g., temperature, speed, and/or power-on time, etc.), and/or damage sensors (e.g., shock sensors and/or moisture sensors, etc.).

Health calculation engine 225 may calculate a health factor for the hard disk drive according to at least one first data element of the plurality of sensor data, and calculate a health offset for the hard disk drive according to at least one second data element of the plurality of sensor data. To calculate the health factor, health calculation engine 225 may be configured to calculate an intermediate health value of 1-100% according to the at least one first data element, square the intermediate health value; and subtract an average operating temperature, squared. In some implementations, the square of the average operating temperature may itself be squared before being subtracted from the intermediate health value, as illustrated in Equation 1, above. To calculate the health offset, health calculation engine 225 may be configured to calculate a time value according to the at least one second data element divided by a total power on time of the hard disk drive.

For example, health calculation engine 225 may execute calculate health factor instructions 125 based on an intermediate health value and/or an average operating temperature. The intermediate health value of the HDD 216 may be represented as a percentage value from 1-100% and associated with a general health of the HDD 216. The health value may be calculated by gathering a number of HDD 216 attributes from the appropriate sensors, normalizing those attributes to a percentage, and assigning a weight to each attribute.

The average operating temperature of HDD 216 may be reported, for example, as an Airflow Temperature attribute, which is the temperature of the air inside the hard disk housing. The average temperature often has a direct correlation to determine the lifetime of a HDD, and the HDD lifetime may be reduced drastically. Health calculation engine 225 may calculate the health factor using these attributes and Equation 1, as described above.

Health calculation engine 225 may execute calculate health offset instructions 130 according to a second subset of sensor data of the plurality of sensor data. The second subset of sensor data may comprise, for example, a drive power cycle count, a shock sensor count, an average temperature, and a reallocated sectors count. In some implementations, the health offset may comprise at least one of the second subset of sensor data divided by a total power on time of the hard disk drive 140. In some implementations, first and second subsets of sensor data may comprise at least one attribute overlapping between the two subsets. For example, both the health factor and the health offset may utilize the Reallocated Sector Count in combination with other attributes for each calculation.

The health offset may define each sensor data value in terms of a total power on time for the drive. For example, the health offset may be calculated according to Equation 2, as described above.

Forecasting engine 230 may generate a remaining lifetime forecast for the hard disk drive according to an estimated overall lifetime for the hard disk drive, the health factor for the hard disk drive, and the health offset for the hard disk drive. In some implementations, the estimated overall lifetime for the hard disk drive may comprise an average overall lifetime for a plurality of hard disk drives associated with a manufacturer and/or a model of the hard disk drive and a model of the hard disk drive. In some implementations, to generate the remaining lifetime forecast, forecasting engine 230 may be configured to calculate an intermediate remaining life value according to the estimated overall lifetime minus a total power on time, multiply the intermediate remaining life value times the health factor, and subtract the health offset, as illustrated in Equation 3, above.

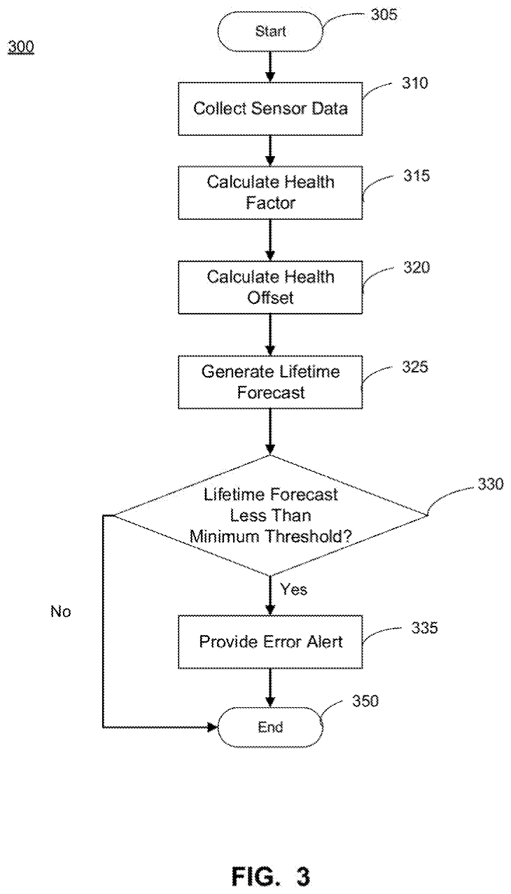

FIG. 3 is a flowchart of an example method 300 for providing hard disk drive lifetime forecasting. Although execution of method 300 is described below with reference to computing device 110, other suitable components for execution of method 300 may be used.

Method 300 may begin at stage 305 and advance to stage 310 where device 110 may collect a plurality of sensor data associated with a hard disk drive, such as HDD 140. For example, collect sensor data instructions 120 may collect a plurality of sensor data associated with a hard disk drive 140 comprising a plurality of sensors 150(A)-(C). For example, sensors 150(A)-(C) may comprise S.M.A.R.T. specification compatible sensors configured to provide data to a Built-In Operating System (BIOS), user Operating System (OS), application, firmware, and/or other executable program associated with computing device 110. Such sensors may comprise, for example, error count sensors, operational sensors (e.g., temperature, speed, and/or power-on time, etc.), and/or damage sensors (e.g., shock sensors and/or moisture sensors, etc.).

Method 300 may then advance to stage 315 where computing device 300 may calculate a health factor for the hard disk drive according to at least one first data element of the plurality of sensor data. For example, device 110 may execute calculate health factor instructions 125 based on an intermediate health value and/or an average operating temperature. The intermediate health value of the HDD 140 may be represented as a percentage value from 1-100% and associated with a general health of the HDD 140. The health value may be calculated by gathering a number of HDD 140 attributes from the appropriate sensors, normalizing those attributes to a percentage, and assigning a weight to each attribute.

The average operating temperature of HDD 140 may be reported, for example, as an Airflow Temperature attribute, which is the temperature of the air inside the hard disk housing. The average temperature often has a direct correlation to determine the lifetime of a HDD, and the HDD lifetime may be reduced drastically. The health factor may thus be calculated using these attributes and Equation 1, as described above.

Method 300 may then advance to stage 320 where computing device 300 may calculate a health offset for the hard disk drive according to at least one second data element of the plurality of sensor data. Health calculation engine 225 may execute calculate health offset instructions 130 according to a second subset of sensor data of the plurality of sensor data. The second subset of sensor data may comprise, for example, a drive power cycle count, a shock sensor count, an average temperature, and a reallocated sectors count. In some implementations, the health offset may comprise at least one of the second subset of sensor data divided by a total power on time of the hard disk drive 140. In some implementations, first and second subsets of sensor data may comprise at least one attribute overlapping between the two subsets. For example, both the health factor and the health offset may utilize the Reallocated Sector Count in combination with other attributes for each calculation. The health offset may define each sensor data value in terms of a total power on time for the drive. For example, the health offset may then be calculated according to Equation 2, as described above.

Method 300 may then advance to stage 325 where computing device 300 may generate a remaining lifetime forecast for the hard disk drive according to an estimated overall lifetime for the hard disk drive, the health factor for the hard disk drive, and the health offset for the hard disk drive. In some implementations, generating the remaining lifetime forecast may comprise calculating an intermediate remaining life value according to the estimated overall lifetime minus a total power on time and multiplying the intermediate remaining life value times the health factor, and subtracting the health offset.

Method 300 may then advance to stage 330 where computing device 300 may determine whether the remaining lifetime forecast for the hard disk drive is lower than a configurable threshold. For example, a remaining lifetime of less than 30 days may be considered below the threshold.

In response to determining that the remaining lifetime forecast for the hard disk drive is lower than the configurable threshold, method 300 may provide an error alert. For example, device 110 may display an error message to a user of device 110, create a log entry in a device log associated with device 110, and/or send a message to a maintenance service and/or help desk to alert a technician of the imminent failure of HDD 140.

Method 300 may then end at stage 350.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed:

1. A non-transitory machine-readable storage medium having stored thereon machine-readable instructions executable to cause a processor to:
collect a plurality of sensor data associated with a hard disk drive;
calculate a health factor for the hard disk drive according to the plurality of sensor data;
calculate a health offset for the hard disk drive according to the plurality of sensor data; and
generate a remaining lifetime forecast for the hard disk drive according to an estimated overall lifetime for the hard disk drive, the health factor for the hard disk drive, and the health offset for the hard disk drive.

2. The medium of claim 1, wherein the health factor is calculated according to a first subset of sensor data of the plurality of sensor data.

3. The medium of claim 2, wherein the first subset of sensor data comprises at least one of the following: a read error count, a command timeout count, a reallocated sectors count, and an uncorrectable sector count.

4. The medium of claim 1, wherein the health offset is calculated according to a second subset of sensor data of the plurality of sensor data.

5. The medium of claim 4, wherein the second subset of sensor data comprises at least one of the following: a drive power cycle count, a shock sensor count, an average temperature, and a reallocated sectors count.

6. The medium of claim 5, wherein the health offset comprises at least one of the second subset of sensor data divided by a total power on time of the hard disk drive.

7. The medium of claim 1, wherein the estimated overall lifetime for the hard disk drive is an average overall lifetime for a plurality of hard disk drives associated with a manufacturer of the hard disk drive.

8. The medium of claim 1, wherein the estimated overall lifetime for the hard disk drive is an average overall lifetime for a plurality of hard disk drives associated with a model of the hard disk drive.

9. A system, comprising:
a data collection engine to collect a plurality of sensor data associated with a hard disk drive;
a health calculation engine to:
calculate a health factor for the hard disk drive according to at least one first data element of the plurality of sensor data, and
calculate a health offset for the hard disk drive according to at least one second data element of the plurality of sensor data; and
a forecasting engine to generate a remaining lifetime forecast for the hard disk drive according to an estimated overall lifetime for the hard disk drive, the health factor for the hard disk drive, and the health offset for the hard disk drive.

10. The system of claim 9, wherein the estimated overall lifetime for the hard disk drive is an average overall lifetime for a plurality of hard disk drives associated with at least one of: a manufacturer of the hard disk drive and a model of the hard disk drive.

11. The system of claim 9, wherein the health calculation engine, to calculate the health factor, is configured to:
calculate an intermediate health value of 1-100% according to the at least one first data element;
square the intermediate health value; and
subtract an average operating temperature, squared.

12. The system of claim 9, wherein the health calculation engine, to calculate the health offset, is configured to calculate a time value according to the at least one second data element divided by a total power on time of the hard disk drive.

13. The system of claim 9, wherein the forecasting engine, to generate the remaining lifetime forecast, is configured to:
calculate an intermediate remaining life value according to the estimated overall lifetime minus a total power on time;
multiply the intermediate remaining life value times the health factor; and
subtract the health offset.

14. A computer implemented method, comprising:
collecting a plurality of sensor data associated with a hard disk drive;
calculating a health factor for the hard disk drive according to at least one first data element of the plurality of sensor data;
calculating a health offset for the hard disk drive according to at least one second data element of the plurality of sensor data;
generating a remaining lifetime forecast for the hard disk drive according to an estimated overall lifetime for the hard disk drive, the health factor for the hard disk drive, and the health offset for the hard disk drive;
determining whether the remaining lifetime forecast for the hard disk drive is lower than a configurable threshold; and
in response to determining that the remaining lifetime forecast for the hard disk drive is lower than a configurable threshold, providing an error alert.

15. The method of claim 14, wherein generating the remaining lifetime forecast comprises:
calculating an intermediate remaining life value according to the estimated overall lifetime minus a total power on time;
multiplying the intermediate remaining life value times the health factor; and
subtracting the health offset.
